(19) United States
(12) Patent Application Publication
(10) Pub. No.: US 2018/0204187 A1
(43) Pub. Date: Jul. 19, 2018

(54) MEETING ROOM RELEASE RESPONSIVE TO DETECTED USERS

(71) Applicant: Lenovo (Singapore) Pte. Ltd., Singapore (SG)

(72) Inventors: Aaron Michael Stewart, Raleigh, NC (US); Jonathan Jen-Wei Yu, Raleigh, NC (US); Jeffrey E. Skinner, Raleigh, NC (US); Lincoln Penn Hancock, Raleigh, NC (US)

(21) Appl. No.: 15/405,535

(22) Filed: Jan. 13, 2017

(51) Int. Cl. G06Q 10/10

(52) U.S. Cl. CPC G06Q 10/1095

(57) ABSTRACT

A method includes receiving an indication of users present in a meeting room at a current time, responsive to a user being in the meeting room, obtaining user identification information corresponding to the detected user in the meeting room, obtaining a schedule for the meeting room identifying users invited to attend a meeting during a current time period, comparing the identifications of the detected users to the invited users to determine if an invited user is in the meeting room, applying a first wait policy responsive to no invited user being in the meeting room, and responsive to successful application of the first wait policy, releasing the meeting room to permit the meeting room to be booked.

### BACKGROUND

As office space per person in many office settings has been increasing, it is becoming increasingly difficult to find available collaboration space. People may waste important time in searching for a room or other collaboration space to use for a meeting or work group.

### SUMMARY

A method includes receiving an indication of users present in a meeting room at a current time, responsive to a user being in the meeting room, obtaining user identification information corresponding to the detected user in the meeting room, obtaining a schedule for the meeting room identifying users invited to attend a meeting during a current time period, comparing the identifications of the detected users to the invited users to determine if an invited user is in the meeting room, applying a first wait policy responsive to no invited user being in the meeting room, and responsive to successful application of the first wait policy, releasing the meeting room to permit the meeting room to be booked.

A computing device includes a processor and a memory device coupled to the processor having instructions stored thereon executable by the processor to determine if an invited user is in a meeting room at a current time within a period for which the room is booked, the period having a booked start time, responsive to determining that no invited user is in the meeting room, determine if an invited user is within a threshold transit time of the meeting room, responsive to determining if an invited user is within a threshold transit time of the meeting room, apply a wait policy to a difference between the booked start time and the current time, and release the room in accordance with application of the wait policy.

A machine readable storage device that is not a transitory signal, has instructions that are executable by a processor to perform operations. The operations include determining if an invited user is in a meeting room at a current time within a period for which the room is booked, the period having a booked start time, responsive to determining that no invited user is in the meeting room, determining if an invited user is within a threshold transit time of the meeting room, responsive to determining if an invited user is within a threshold transit time of the meeting room, applying a wait policy to a difference between the booked start time and the current time, and releasing the room in accordance with application of the wait policy.

### BRIEF DESCRIPTION OF THE DRAWINGS

FIG. 1 is a block diagram illustrating an office environment with meeting rooms according to an example embodiment.

FIG. 2 is a data structure representation of a calendar for multiple example meeting rooms according to an example embodiment.

FIG. 3 is a flowchart illustrating a method of determining when to release a previously scheduled room according to an example embodiment.

FIG. 4 is a flowchart illustrating a computer implemented method of permitting a currently booked meeting room to be booked if invited users are not present for an amount of time after a scheduled start time of a meeting according to an example embodiment.

FIG. 5 is a flowchart illustrating an alternative computer implemented method of permitting a currently booked meeting room to be booked responsive to no invited users being present in the meeting room or nearby and within compliance of a wait time policy according to an example embodiment.

FIG. 6 is a flowchart illustrating a method of automatically checking with users to determine if they intend to use the meeting room according to an example embodiment.

FIG. 7 is a block diagram of computer system used to implement methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. The article “a” or “an” means “one or more” unless explicitly limited to a single one.

Many office environments rely on a network based room booking system in which users check room availability through a calendaring database (e.g. Exchange server). To determine whether a respective room has been booked, users utilize Outlook or some other booking tool (e.g. SteelCase Room Wizard) to complete the booking. Common issues with this involve a booked room not being actively used (e.g. the original requestors never arrived) or the original requestors ending their meeting ahead of their scheduled end time. In both instances, a space is literally available for use but is reported as booked in the scheduling system. Steelcase's Room Wizard has the option to automatically release a room if users do not initiate use of a room by pressing a “Start” button on a digital sign located near the room. While potentially effective, not all users may remember to hit the “Start” button.

Meeting room booking solutions like Robin have experimented with using motion sensing in the room to help resolve requested use from active use (although this is not productized). The prototype solution will release a requested room or automatically book an occupied room based on the data it gathers from the motion sensor. However, this solution is unaware of who may be moving in the room. Knowing the users present would help determine rightful presence versus squatting.

A room booking system leverages various combinations of a web-based calendaring database, in-room sensing of physical presence, in-room sensing of user identity via varying methods, awareness of where involved users currently are if they are not in the room, and patterns of historic use for both a respective room and a respective user. The room booking system will facilitate finding a room for immediate use even if the room was previously booked, but not currently being used, or likely to be used by the rightful attendees.

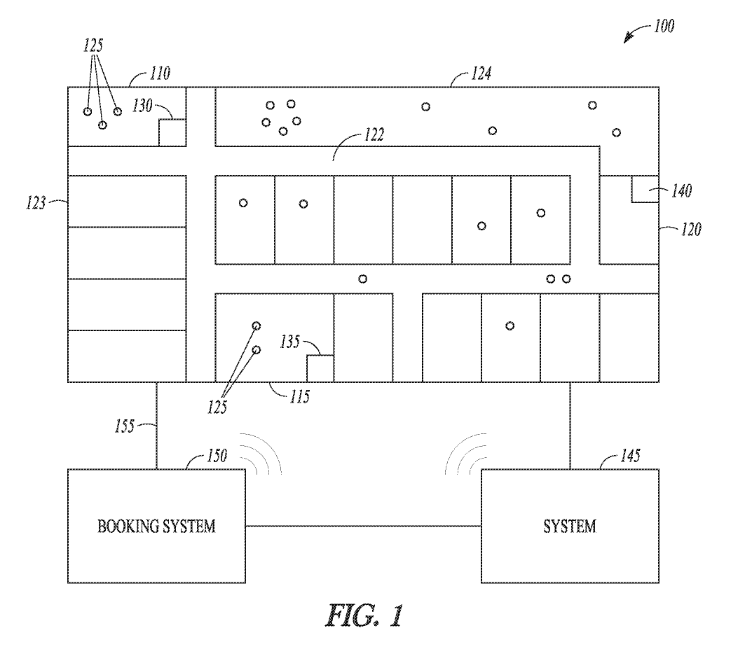

FIG. 1 is a block diagram illustrating an office environment 100. Office environment 100 includes one or more collaboration rooms, such as meeting rooms 110, 115, and 120 available for reserving for collaboration by people in the office environment 100. The office environment 100 is shown as a single level environment for ease of illustration, but may be representative of multiple level buildings and multiple buildings on a campus or even remote location that are available for use by people associated with the office environment 100.

Other areas of the office environment 100 may include hallways 122, individual offices 123, modular offices in open areas 124, and other common spaces that are not commonly treated as meeting rooms. In one example view of office space 100, corresponding to a specific time, say 10:05 AM, locations of people 125 are shown by small circles. Meeting room 110 is shown with three people in the room. Meeting room 115 is shown with two people in the room, and meeting room 120 is shown with no people in the room. People are also shown throughout the office environment 100 at various locations outside of the meeting rooms.

In one embodiment, one or more meeting rooms may include a device or devices 130, 135, and 140 including sensors which may be operable to perform at least one, and various combinations of the following functions, such as detect basic proximity of a user (e.g. IR-based proximity detection), identify identities of users present by identifying a personal device carried by the person (e.g. Bluetooth proximity), voice detection, image sensing, or use of near-field communications that see identity cards or wearable devices that may be used at the rooms entry or at the communal device. Such device or devices 130, 135, and 140 may be referred to as a communal device 130, 135, and 140 in one embodiment, and may include a networked system 145 that tracks employee location on the office campus via: GPS beaconing from a personal device (e.g. LBS on the smartphone), sensing proximity between a personal device and an array of sensor nodes throughout the campus via Bluetooth, Wi-Fi Aware or other IoT (Internet of Things) protocol.

Each meeting room in one embodiment has a calendar associated with it showing meetings that are scheduled, as well as open times. A scheduled meeting may include a list of attendees, identified by email address or other unique identifier. The office environment 100 relies on a network-based booking system 150 (e.g. Outlook & Exchange server) which may have wired connections 155, or a wireless connection to the communal devices and user devices.

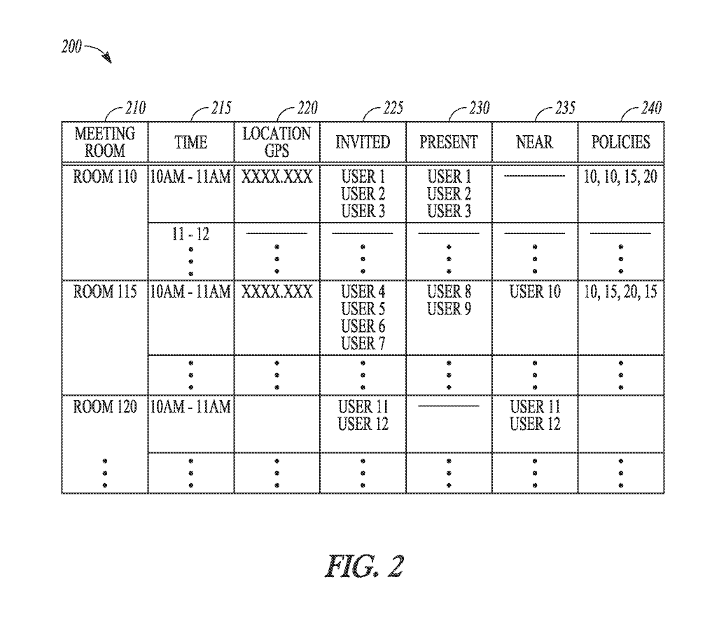

FIG. 2 is a data structure 200 representation of a calendar for multiple example meeting rooms in column 210, such as meeting rooms 110, 115, and 120 for a present time. In one example all three meeting rooms are shown as scheduled for a meeting at a current time, 10:05 AM, when a user is looking for an available meeting space for immediate use. Times for each room are indicated in column 215. A location of the room, such as GPS coordinates or other location identifying data is provided in column 220. Meeting room 110 is shown with three attendees invited, user 1, user 2, and user 3 as indicated in column 225. The communal device 130 detects that there are three people currently in meeting room 110 and indicates such at column 230. Three people corresponds well with the number of people actually scheduled to use the room. To ensure that the three users are the same users scheduled to use meeting room 110, an additional check is performed. The identities of the users may be determined via one or more of multiple different mechanisms. Voice recognition may be used by comparing voices in the room with known voice profiles for each user. RFID identification badges, or mobile device location mechanisms may be used in further embodiment. In this example, all three users check out as the users actually scheduled or invited to use the room.

Meeting room 115 is shown as having a meeting currently scheduled that includes four users, users 4, 5, 6, and 7. The corresponding communal device 135 shows that two people, users 8 and 9 are currently in the room. Note that in FIG. 1, there is also at least one third person just outside the entrance to meeting room 115, indicated in column 235 as near. How near may be set by a user or administrator, and may generally include users within 20 to 50 feet of the meeting room. Other distances may be used as desired. The distance in some embodiments correlates to a transit time to reach the meeting room. If the user is in the same building on the same floor as the meeting and within 20 to 50 feet, the transit time may be implied to be within a minute or so. If the distance is within a mile, and the speed that the user is traveling as estimated from a rate of change of the distance is indicative of the user reaching the meeting within a few minutes, the transit time may be similar to that of a user just outside of the building housing the meeting room. In some embodiments, it may be assumed that users are traveling by foot to the meeting. In such embodiments, either the distance or estimated transit time may be used to determine that a user will not be attending the meeting, allowing the room to be released.

Note that in this example, neither the two users in the room, nor the third person just outside the entrance are actually on the schedule for meeting room 115. Such users may be referred to as squatters, and meeting room 115 may be found to be available for a meeting at the current time, and can be reserved provided a sufficient time has passed. Column 240 provides four different times that may be used and are referred to as different policies, which are described in further detail below.

Meeting room 120 has no users in the room, but does have two users within about twenty feet of the room, corresponding to a short transit time. Meeting room 120 is shown as having two users scheduled to currently use the room. Two users within about 20 feet of the room are actually on the schedule, and it may be determined that they are likely going to use meeting room 120. Thus, meeting room 120 is validly booked, and not available. In some embodiments, if the two users are in a location that corresponds to their office, and a sufficient amount of time has passed indicative of it not being likely that they will be using the meeting room 120, meeting room 120 may be released for use, and reserved.

In some embodiments, the locations of users scheduled to use a meeting room may be found to be too far from a room to actually use the room at a time for which the meeting room is reserved. This time may be in the future, such as in a few hours or more, and perhaps the user is quite far away, such as in another country. Such a meeting room may be released for reserving if all scheduled users are unlikely to be able to make the meeting.

In still further embodiments, behavioral patterns of users may be taken into account when determining whether or not a user is likely to use a reserved meeting room. For instance, if a user generally leaves the office early on a Friday, and perhaps has a dinner meeting scheduled that would require leaving early, a meeting room may be released. In still further embodiments, a user usually missing a meeting at a particular time of day may be taken into account.

In some embodiments, an email or call may be placed to one or more users to indicate that their room will be released unless occupied by one or more scheduled users within a certain amount of time, such as five minutes to ten minutes. Following expiration of that time without occupancy or confirmation of intent to user the room, the room may be released.

In one embodiment, the booking system 150, or a system coupled to the booking system 150, such as system 145, provides a logging of historic usage patterns for both users and respective rooms. The log accounts for patterns in use based on time of day, personal tendencies and other contextually relevant data:

The logging may include patterns such as a pattern that a respective user is likely to be X minutes late to meetings, a respective user is likely to attend meetings that are X feet from her present position, and other patterns as previously mentioned.

The logging may also include patterns related to meeting rooms, such as a respective room is unlikely to get used in the afternoons or on Fridays, etc., a respective room is likely to be used only if other respective rooms are concurrently occupied, or users are often late/early to this room

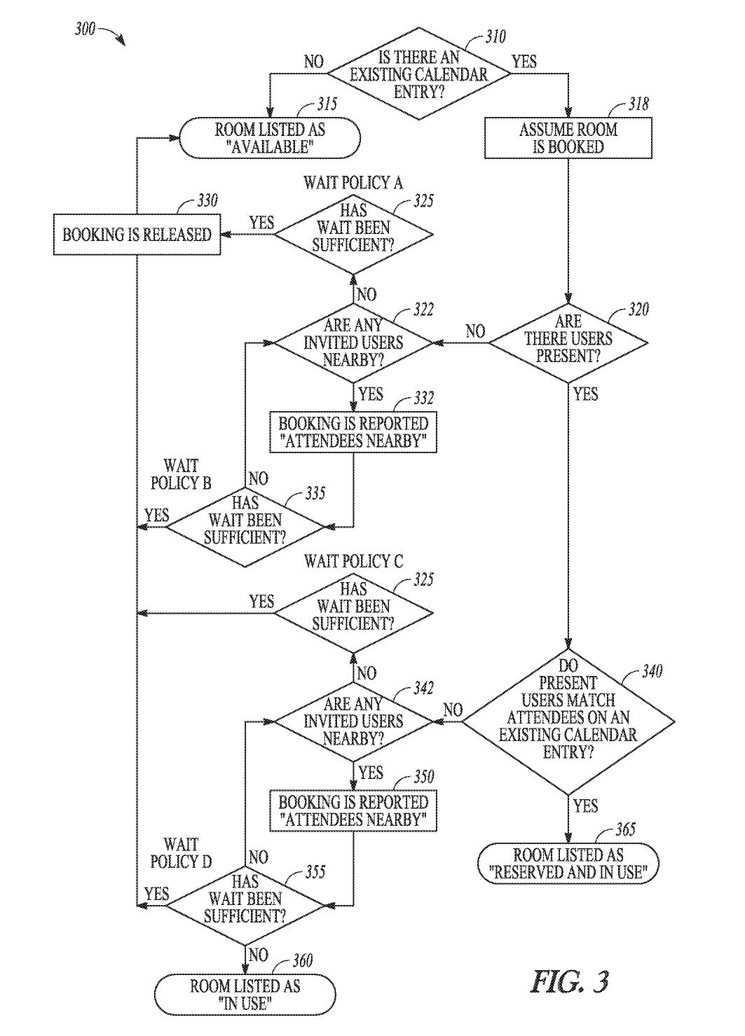

FIG. 3 is a flowchart illustrating a method 300 of determining when to release a previously scheduled room. In one embodiment, method 300 is augmented by artificial intelligence software, such as neural network that determines whether the room can be shown as “available,” “in use” or “reserved and in use” in the booking system 150. There are decision intersections to get to certain determinations with each decision governed by a specific “wait policy” that applies to the respective context. The wait policy may include multiple sub-wait policies that can crudely be a set to a given time or could be adjusted dynamically based on nearness/transit time of any of the expected attendees as well as the usage pattern biases that are established in the user and room historical log. In some embodiments, the wait policy may be affected by real-time measures of overall building occupancy as may be determined by badge readers or other sensors, and may also or alternatively be based on knowledge of a level or nearby meeting room vacancies. Wait times may be increased or decreased as desired based on such measures and/or knowledge. Once the time for each policy is determined, it may be added to column 240 of data structure 200 for use by method 300 in performing comparisons.

Method 300 may begin when a user requests a meeting room for immediate use, or within a user specified time, and there are no meeting rooms currently available in the booking system 150. In further embodiments, method 300 may run continuously and release rooms for use as the method determines appropriate without an outstanding request for rooms. Such continuous running ensures an anonymity of booking rooms for a user looking for a current room to use in that they need not be aware that an existing booked meeting was bumped.

In one embodiment, the user may select a room to perform method 300 on, or ask for a room that might be available. Method 300 may be performed on a list of potential rooms until one is found and released. Potential rooms may include rooms near a user or in a selected building or buildings in one example. For each room, booking system 150 checks at 310 if there is an existing calendar entry. If not, the room is listed as available at 315 and may be reserved by the user. If the room is booked, as indicated at 318, a check is made at 320 to determine if there are users present, which may include detecting a single user. Data structure 200 may be updated via a corresponding communal device to indicate that users are present and checked at 320.

If no users are present, a check may be made at 322 to determine if any invited users are nearby. If not, a first wait policy is checked at 325 to see if a selected amount of time has passed since a scheduled start of the currently scheduled meeting. The first wait policy may be referred to as a first sub-policy of an overall wait policy. That time may be preselected by a user or administrator. Example wait times may be between 5 and 20 minutes in one embodiment, or a time outside that range if desired. Note that the wait times may also be determined based on patterns for the room and invited users. If the invited users are usually very timely, the wait time may be less, but if the invited users usually attend, and are also usually late, the wait time may be increased. If the wait time has been sufficient at 325, the booking for the room is released at 330 and listed as available at 315.

If there are invited users nearby as determined at 322, the room is noted as booked with attendees nearby at 332, and a check is made at 335 to determine if a second wait policy permits releasing the booking at 330. The second wait policy may also be determined similarly to the first wait policy and can be either predetermined, or derived from patterns of logged room use and user behavior. If the second wait policy has not been met, the method 300 returns to 332 and loops or otherwise waits until the second policy has been met to release the room. The loop may be periodic, such as once per minute, or may be delayed by an amount corresponding to a time remaining to meet the time specified in the second wait policy.

If it is determined at 320 that users are present in the meeting room, a check may be done at 340 to determine if the users that are present match the attendees on an existing calendar entry for the room, or alternatively for an organizer of the meeting. If none of the users that are present match such attendees, a check is made at 342 to determine if any invited users are nearby. If not, a third wait policy is checked at 345 to see if the wait has been sufficient to release the room at 330 and allow a user to book the room. The third wait policy may be the same as the first wait policy and may be determined in a similar manner. In some embodiments, users may be identified as privileged users that should not be evicted from a room even if they do not have the room reserved. Such users for example may include high level managers, managers of a user, or others working on high priority projects. The wait policies may take such information in account when determining wait times for each of the different policies.

If users are nearby as indicated at 342, booking is reported with attendees nearby at 350 and a check of a fourth wait policy is performed at 355. The fourth wait policy may be determined in a manner similar to the other wait policies. If the wait has been sufficient, booking of the room is released at 330. If the wait time has not been sufficient, the room may be listed as in use. Method 300 may wait and recheck the room or may simply perform the method for a different room. Note that in some embodiments, method 300 may be performed on multiple rooms at the same time to provide a user with a list of options.

In some embodiments, method 300 may be performed as a background task on all meeting rooms such that rooms may be released automatically and available to any user asking for a meeting room. In further embodiments, the first, second, third, and fourth wait policies are sub-wait policies that may take into account a position or status of a user requesting a room and modify the wait policies accordingly. If the user is a high level manager, or working on a high priority project, the wait policies may adjust to reduce the amount of time required to wait for the room to be released.

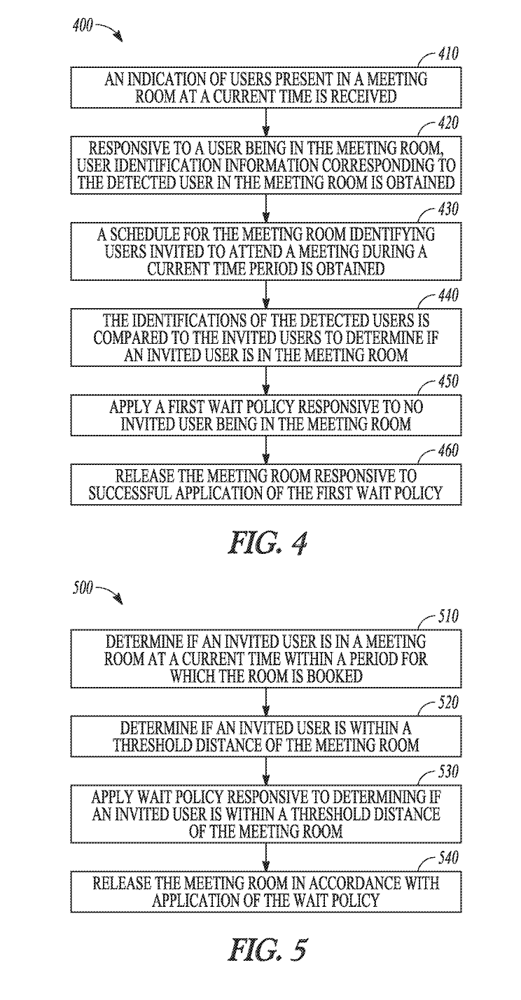

FIG. 4 is a flowchart illustrating a computer implemented method 400 of permitting a currently booked meeting room to be booked if invited users are not present for an amount of time after a scheduled start time of a meeting. At 410, an indication of users present in a meeting room at a current time is received. Responsive to a user being in the meeting room, at 420, user identification information corresponding to the detected user in the meeting room is obtained, such as from a location identification system. At 430, a schedule for the meeting room identifying users invited to attend a meeting during a current time period is obtained. The schedule may contain information similar to that shown in data structure 200. At 440, the identifications of the detected users is compared to the invited users to determine if an invited user is in the meeting room. A first wait policy is applied at 450 responsive to no invited user being in the meeting room. Responsive to successful application of the first wait policy, such as a time from the start of the meeting or exceeding a time specified in the first wait policy, the meeting room is released at 460 to permit the meeting room to be booked.

FIG. 5 is a flowchart illustrating an alternative computer implemented method 500 of permitting a currently booked meeting room to be booked responsive to no invited users being present in the meeting room or nearby and within compliance of a wait time policy. The wait time policy may include different wait times for different scenarios, such as whether or not the room is occupied, whether invited users are at least one of the occupants, and whether invited users are nearby, such as within a specified threshold distance. The specified threshold distance may be different for each room, or different specific users, or a combination of both based on historical patterns of behavior associated with the meeting room and/or specific users.

Method 500 begins responsive to a user requesting a collaborative space, such as a meeting room for immediate use in one embodiment. At 510, it is determined if an invited user is in a meeting room at a current time within a period for which the room is booked. The booking of the room for that period has an associated booked start time. Responsive to determining that no invited user is in the meeting room, at 520, it is determined if an invited user is within a threshold distance of the meeting room. At 530, responsive to determining if an invited user is within a threshold distance of the meeting room, a wait policy is applied to a difference between the booked start time and the current time. At 540, the meeting room is released in accordance with application of the wait policy, such as the elapsed time from the start time meets or exceeds a time specified in the wait policy for the particular combination of constraints.

In various examples associated with methods 300, 400, and 500, those constraints include no user being present in the meeting room and no invited users being nearby. In further examples, the wait policy time may be different if some users, but no invited users are in the room and no invited users are nearby, or if no user is in the room and an invited user is nearby, or if none of the users in the room are invited and an invited user is nearby.

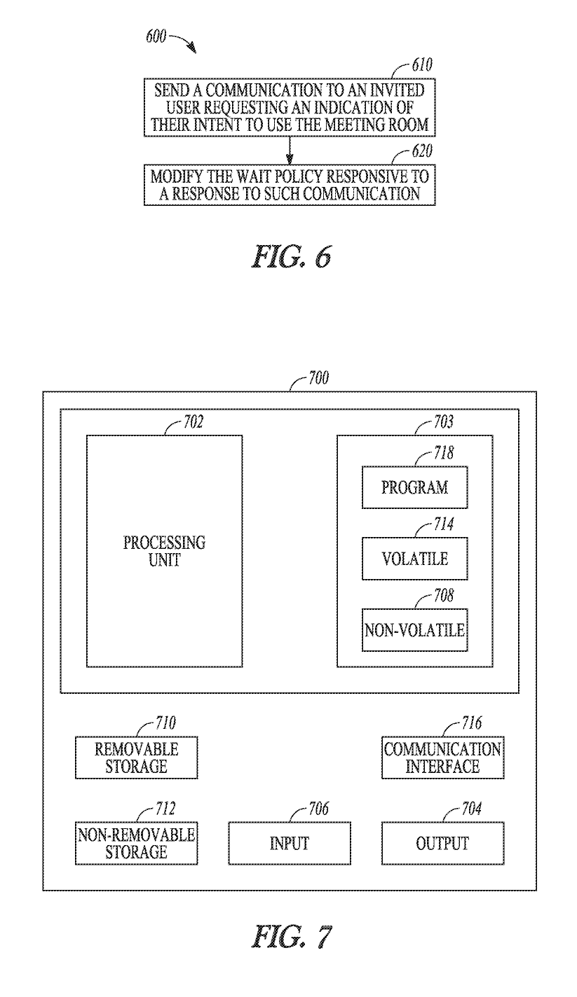

FIG. 6 is a flowchart illustrating a method 600 of automatically checking with users to determine if they intend to use the meeting room. In one embodiment, method 600 will generate and send a communication at 610 to an invited user or multiple invited users requesting an indication of their intent to use the meeting room. The communication may be generated responsive to a meeting room not having any invited users present within a time after the start time of a scheduled meeting in some embodiments, and may also be responsive to a user requesting the meeting room. An example communication may be an email or text, or other communication having a form similar to: “You are late to a scheduled meeting in room 5K20. Are you planning to use the room? Please check the yes or no box below.” At 620, the wait policy may be modified responsive to a response to such communication. The response may take the form of an active response indicating an intent to use the room, an intent not to use the room, or no response. An active response indicating an intent to use the room may increase a wait time in the wait policy. An active response indicating an intent not to use the room may cause a release of the room if received from an organizer or alternatively from all users. A response comprising no response may shorten a wait time, or leave the wait time the same as desired.

FIG. 7 is a block schematic diagram of a computer, 700 to implement device 100 and other computing resources according to example embodiments. All components need not be used in various embodiments. One example computing device in the form of a computer 700, may include a processing unit 702, memory 703, removable storage 710, and non-removable storage 712. Sensors 115 and 125 may be coupled to provide data to the processing unit 702. Memory 703 may include volatile memory 714 and non-volatile memory 708. Computer 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 700 may include or have access to a computing environment that includes input 706, output 704, and a communication connection 716. Output 704 may include a display device, such as a touchscreen, that also may serve as an input device. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 702 of the computer 700. A hard drive, CD-ROM, DRAM, and RAM are some examples of data storage devices including a non-transitory computer-readable medium. For example, a computer program 718 may be used to cause processing unit 702 to perform one or more methods or algorithms described herein. Computer program 718 may be stored on a device or may be downloaded from a server to a device over a network such as the Internet. Computer-readable instructions may also be included on a computer readable storage medium that is being vended and/or provided, where the computer readable storage medium is defined as not encompassing a transitory signal, carrier wave, and/or a signal per se.

### EXAMPLES

In example 1, a method includes receiving an indication of users present in a meeting room at a current time, responsive to a user being in the meeting room, obtaining user identification information corresponding to the detected user in the meeting room, obtaining a schedule for the meeting room identifying users invited to attend a meeting during a current time period, comparing the identifications of the detected users to the invited users to determine if an invited user is in the meeting room, applying a first wait policy responsive to no invited user being in the meeting room, and responsive to successful application of the first wait policy, releasing the meeting room to permit the meeting room to be booked.

Example 2 includes the method of example 1 and further includes responsive to no user being present in the meeting room, receiving an indication of invited users within a specified transit time from the meeting room, and applying the first wait policy responsive to no invited users being within the specified transit time to determine whether or not to release the meeting room.

Example 3 includes the method of example 2 and further includes responsive to no user being present in the meeting room, receiving an indication of invited users within a specified transit time from the meeting room, and applying a second wait policy as a function of such users within the specified transit time to determine whether or not to release the meeting room.

Example 4 includes the method of example 3 wherein the second wait policy is applied periodically until a time associated with the second wait policy has passed at which time the booking of the meeting room is released.

Example 5 includes the method of example 3 and further includes responsive to a user being present, but no invited user being one of the users present in the meeting room, receiving an indication of invited users within a specified transit time from the meeting room, and applying a third wait policy responsive to no invited users being within the specified transit time to determine whether or not to release the meeting room.

Example 6 includes the method of example 5 and further includes responsive to a user being present, but no invited user being present in the meeting room, receiving an indication of invited users within a specified transit time from the meeting room, and applying a fourth wait policy as a function of such invited users within the specified transit time to determine whether or not to release the meeting room.

Example 7 includes the method of example 6 wherein the fourth wait policy is applied periodically until a time associated with the fourth wait policy has passed at which time the booking of the meeting room is released.

Example 8 includes the method of any of examples 1-7 and further comprising logging meeting room historic usage patterns for each meeting room and users, and wherein each wait policy is a function of such patterns of historic use.

Example 9 includes the method of any of examples 1-8 wherein the indication of users present in a meeting room at a current time is received from a communal device in each room.

In example 10, a computing device includes a processor and a memory device coupled to the processor having instructions stored thereon executable by the processor to determine if an invited user is in a meeting room at a current time within a period for which the room is booked, the period having a booked start time, responsive to determining that no invited user is in the meeting room, determine if an invited user is within a threshold transit time of the meeting room, responsive to determining if an invited user is within a threshold transit time of the meeting room, apply a wait policy to a difference between the booked start time and the current time, and release the room in accordance with application of the wait policy.

Example 11 includes the computing device of example 10 wherein determining if an invited user is in a meeting room at a current time comprises reading a schedule data structure that indicates a location of the invited user and a location of the meeting room, and estimating the amount of time needed for invited user to reach the meeting room location.

Example 12 includes the computing device of any of examples 10-11 wherein determining if an invited user is within a threshold transit time of the meeting room comprises reading a schedule data structure that indicates a location of the invited user and a location of the meeting room, estimating the transit time, and comparing the estimated transit time to the threshold transit time.

Example 13 includes the computing device of any of examples 10-12 wherein the instructions are further executable to determine if a user is in the meeting room and whether or not such user is an invited user.

Example 14 includes the computing device of example 13 wherein the wait policy is different for whether a user is in the meeting room and not an invited user and whether there are invited users within the threshold transit time of the meeting room.

Example 15 includes the computing device of any of examples 10-14 wherein the wait policy is different as a function of whether users are in the meeting room, no users are within the meeting room, and whether invited users are within the threshold transit time of the meeting room.

Example 16 includes the computing device of example 15 wherein each wait policy comprises a time indicative of a time from which a booked meeting is scheduled.

Example 17 includes the computing device of any of examples 10-16 wherein the instructions are further executable by the processor to send a communication to an invited user requesting an indication of their intent to use the meeting room, and modify the wait policy responsive to a response to such communication.

In example 18, a machine readable storage device that is not a transitory signal, having instructions that are executable by a processor to perform operations including determining if an invited user is in a meeting room at a current time within a period for which the room is booked, the period having a booked start time, responsive to determining that no invited user is in the meeting room, determining if an invited user is within a threshold transit time of the meeting room, responsive to determining if an invited user is within a threshold transit time of the meeting room, applying a wait policy to a difference between the booked start time and the current time, and releasing the room in accordance with application of the wait policy.

Example 19 includes the machine readable storage device of example 18 wherein determining if an invited user is in a meeting room includes obtaining a schedule data structure having data identifying times the meeting room is booked, an identification of invited users, and a corresponding wait policy, obtaining identifications of users in the meeting room at the current time, and comparing the identifications of the invited users with the identifications of user in the meeting room at the current time.

Example 20 includes the machine readable storage device of example 19 wherein determining if an invited user is within a threshold transit time of the meeting room includes obtaining identifications of users within the threshold transit time from a location identification system, and comparing the identifications of the invited users with the identification of users within the threshold transit time to identify invited users within the threshold transit time, and using such comparison in combination with the wait policy to determine whether to release the meeting room for current booking.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
receiving an indication of users present in a meeting room at a current time;
responsive to a user being in the meeting room, obtaining user identification information corresponding to the detected user in the meeting room;
obtaining a schedule for the meeting room identifying users invited to attend a meeting during a current time period;
comparing the identifications of the detected users to the invited users to determine if an invited user is in the meeting room;
applying a first wait policy responsive to no invited user being in the meeting room; and
responsive to successful application of the first wait policy, releasing the meeting room to permit the meeting room to be booked.

2. The method of claim 1 and further comprising:
responsive to no user being present in the meeting room, receiving an indication of invited users within a specified transit time from the meeting room; and
applying the first wait policy responsive to no invited users being within the specified transit time to determine whether or not to release the meeting room.

3. The method of claim 2 and further comprising:
responsive to no user being present in the meeting room, receiving an indication of invited users within a specified transit time from the meeting room; and
applying a second wait policy as a function of such users within the specified transit time to determine whether or not to release the meeting room.

4. The method of claim 3 wherein the second wait policy is applied periodically until a time associated with the second wait policy has passed at which time the booking of the meeting room is released.

5. The method of claim 3 and further comprising:
responsive to a user being present, but no invited user being one of the users present in the meeting room, receiving an indication of invited users within a specified transit time from the meeting room; and
applying a third wait policy responsive to no invited users being within the specified transit time to determine whether or not to release the meeting room.

6. The method of claim 5 and further comprising:
responsive to a user being present, but no invited user being present in the meeting room, receiving an indication of invited users within a specified transit time from the meeting room; and
applying a fourth wait policy as a function of such invited users within the specified transit time to determine whether or not to release the meeting room.

7. The method of claim 6 wherein the fourth wait policy is applied periodically until a time associated with the fourth wait policy has passed at which time the booking of the meeting room is released.

8. The method of claim 1 and further comprising logging meeting room historic usage patterns for each meeting room and users, and wherein each wait policy is a function of such patterns of historic use.

9. The method of claim 1 wherein the indication of users present in a meeting room at a current time is received from a communal device in each room.

10. A computing device comprising:
a processor; and
a memory device coupled to the processor having instructions stored thereon executable by the processor to:
determine if an invited user is in a meeting room at a current time within a period for which the room is booked, the period having a booked start time;
responsive to determining that no invited user is in the meeting room, determine if an invited user is within a threshold transit time of the meeting room;
responsive to determining if an invited user is within a threshold transit time of the meeting room, apply a wait policy to a difference between the booked start time and the current time; and
release the room in accordance with application of the wait policy.

11. The computing device of claim 10 wherein determining if an invited user is in a meeting room at a current time comprises reading a schedule data structure that indicates a location of the invited user and a location of the meeting room, and estimating the amount of time needed for invited user to reach the meeting room location.

12. The computing device of claim 10 wherein determining if an invited user is within a threshold transit time of the meeting room comprises reading a schedule data structure that indicates a location of the invited user and a location of the meeting room, estimating the transit time, and comparing the estimated transit time to the threshold transit time.

13. The computing device of claim 10 wherein the instructions are further executable to determine if a user is in the meeting room and whether or not such user is an invited user.

14. The computing device of claim 13 wherein the wait policy is different for whether a user is in the meeting room and not an invited user and whether there are invited users within the threshold transit time of the meeting room.

15. The computing device of claim 10 wherein the wait policy is different as a function of whether users are in the meeting room, no users are within the meeting room, and whether invited users are within the threshold transit time of the meeting room.

16. The computing device of claim 15 wherein each wait policy comprises a time indicative of a time from which a booked meeting is scheduled.

17. The computing device of claim 10 wherein the instructions are further executable by the processor to:
send a communication to an invited user requesting an indication of their intent to use the meeting room; and
modify the wait policy responsive to a response to such communication.

18. A machine readable storage device that is not a transitory signal, having instructions that are executable by a processor to perform operations comprising:
determining if an invited user is in a meeting room at a current time within a period for which the room is booked, the period having a booked start time;
responsive to determining that no invited user is in the meeting room, determining if an invited user is within a threshold transit time of the meeting room;
responsive to determining if an invited user is within a threshold transit time of the meeting room, applying a wait policy to a difference between the booked start time and the current time; and
releasing the room in accordance with application of the wait policy.

19. The machine readable storage device of claim 18 wherein determining if an invited user is in a meeting room comprises:
obtaining a schedule data structure having data identifying times the meeting room is booked, an identification of invited users, and a corresponding wait policy;
obtaining identifications of users in the meeting room at the current time; and
comparing the identifications of the invited users with the identifications of user in the meeting room at the current time.

20. The machine readable storage device of claim 19 wherein determining if an invited user is within a threshold transit time of the meeting room comprises:
obtaining identifications of users within the threshold transit time from a location identification system; and
comparing the identifications of the invited users with the identification of users within the threshold transit time to identify invited users within the threshold transit time; and
using such comparison in combination with the wait policy to determine whether to release the meeting room for current booking.
